(19) United States
(12) Patent Application Publication
(10) Pub. No.: US 2016/0159134 A1
(43) Pub. Date: Jun. 9, 2016

(54) Bookmark Having Plush Animal Tail

(71) Applicant: Gatekeeper, LLC, Plainfield, IN (US)

(72) Inventor: Charnjit S. Pabla, Plainfield, IN (US)

(21) Appl. No.: 14/560,095

(22) Filed: Dec. 4, 2014

(51) Int. Cl. B42D 9/00

(52) U.S. Cl. CPC B42D 9/001

(57) ABSTRACT

A bookmark having a plush animal tail includes a card member comprising indicia representing an animal and a plush tail corresponding to the animal represented by the indicia and attached to the card member such that the plush tail appears to extend from the animal.

### BRIEF DESCRIPTION OF THE DRAWINGS

The novel bookmark is described with reference to the accompanying drawings. In the drawings, like reference numbers indicate identical or functionally similar elements.

FIG. 1 illustrates a first embodiment of an exemplary bookmark;

FIG. 2 shows the components of a tail for the bookmark of FIG. 1;

FIG. 3 shows the bookmark inserted into a book;

FIG. 4 depicts a method of making a bookmark; and

FIGS. 5A through 5C show various embodiments of tails that may be used with the bookmark.

### DETAILED DESCRIPTION

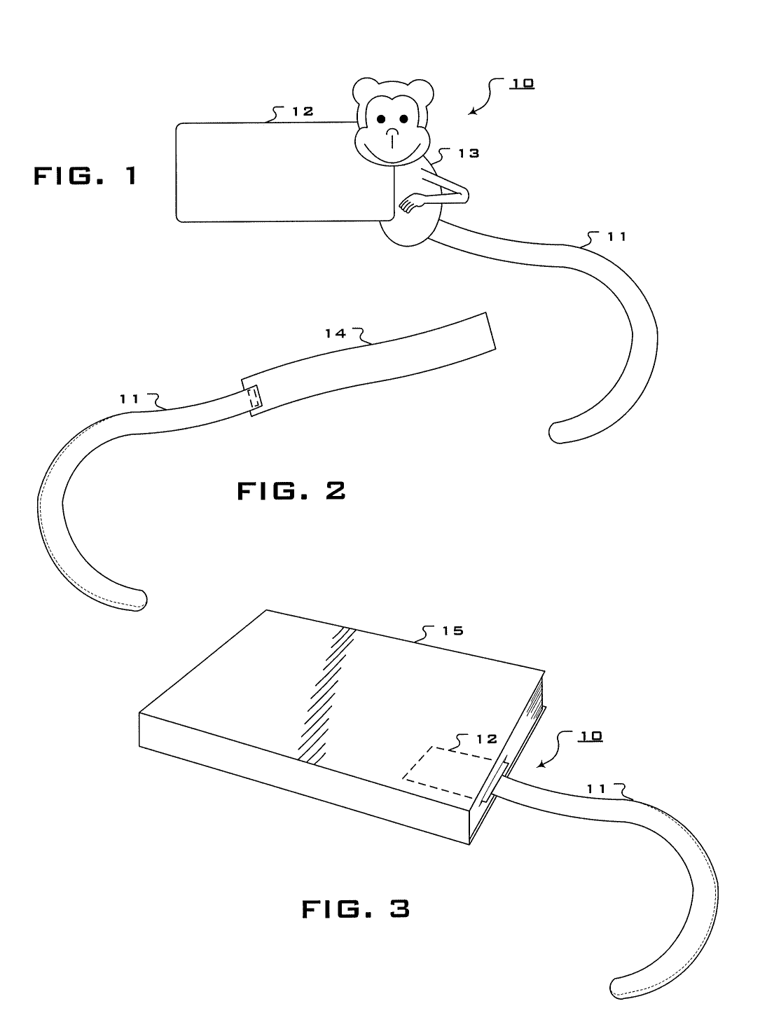

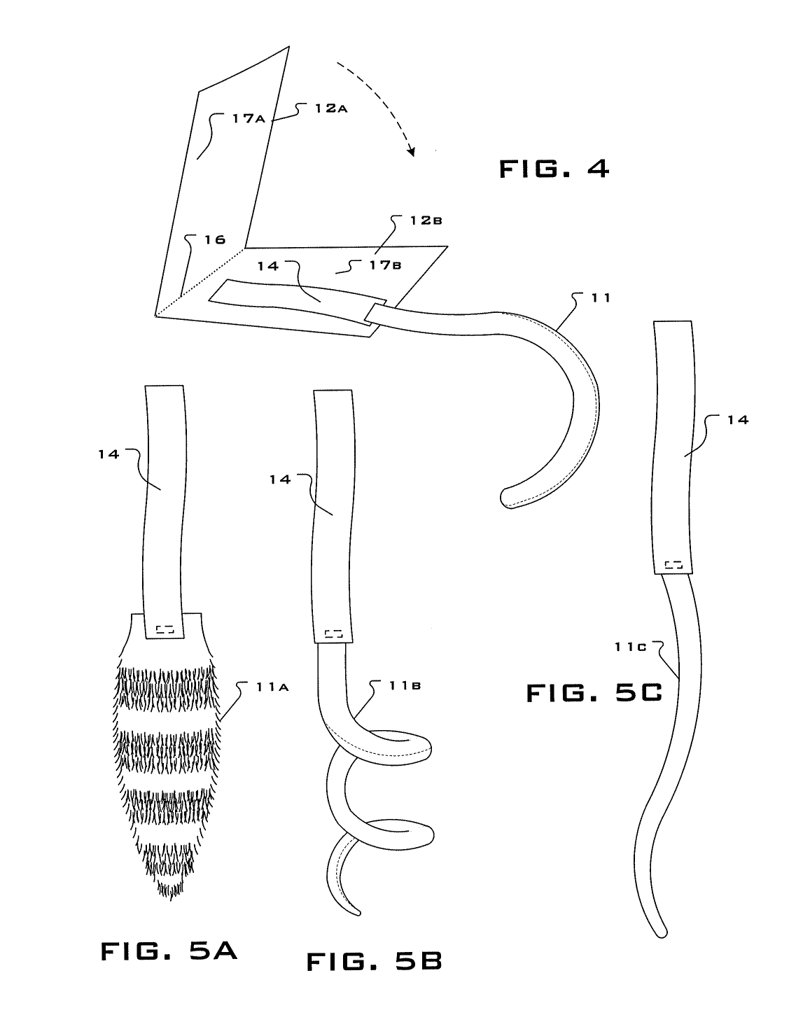

The various embodiments of the novel bookmark and their advantages are best understood by referring to FIGS. 1 through 5C of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

An exemplary bookmark 10 is shown in FIG. 1 and includes a card 12 that includes graphic indicia representing an animal 13. In another embodiment, the card 12 maybe include a shaped portion representing the shape of an animal. The bookmark 10 also comprises a tail 11 attached to the card, which may be a plush tail, that corresponds to the type of animal represented by the graphic indicia and/or shaped portion 13. For example, if the graphic indicia represented a monkey, the tail 11 would approximate that of a monkey. The tail 11 is attached to the card such that it appears to extend from the animal comprised in the card. Referring to FIG. 3, the bookmark 10 may be used by interposing the card portion 12 between the pages of a book 15 with the tail 11 extending therefrom.

In one embodiment, the tail 11 is attached to the card by first fixedly attaching one end of the tail 11 to one end of an elongated strip 14 comprising a flexible material, e.g., a fabric. Tail 11 may be attached by any suitable method, including stitching, riveting or gluing. The card 12 may then comprise a bi-fold card having two substantially equal sections 12a, 12b defined by a fold 16. The interior surfaces 17a, 17b of the sections 12a, 12b comprise an adhesive. The strip 14 is laid between the sections 12a, 12b so that one surface comes in contact with the adhesive on the surface 17b of section 12b and with the tail 11 extending outward such that it appears to extend from the graphic representation of the animal 13. The opposing section 12a is pressed toward section 12b so that the adhesive surface 17a covers both the strip 14 and the opposing surface 17b.

It will be appreciated that the card 12 may include representations of various animals. Likewise, the tail portions 11 may represent the corresponding tails of such animals depicted on the card 12. It will also be appreciated that the card 12 may comprise any suitable material, including paper, card stock, plastic, vinyl or other polymeric material.

FIGS. 5A through 5C illustrate possible tails that may be used, including a raccoon tail 11a, a pig tail 11b, and a mouse tail 11c. Tails may be fabricated by forming an elongated pocket of a suitable fabric of appropriate color and texture, e.g., furry, and stuffing the pocket with a stuffing material. For some tails, the monkey tail 11, the pig tall 11b, or the mouse tail 11c, a length of elongated bendable wire, may be inserted into the pocket to give the tail a formable structure. In this way, the tail 11 may be bent to represent a prehensile tail of a monkey, or the curly tail of a pig, for example.

As described above and shown in the associated drawings, the present invention comprises a bookmark having a plush animal tail. While particular embodiments have been described, it will be understood, however, that any invention appertaining to the bookmark described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A bookmark comprising:
a card member comprising indicia representing an animal;
a plush tail corresponding to the animal represented by said indicia on said card member and attached to said card member such that said plush tail appears to extend from the animal represented by said indicia.

2. The bookmark of claim 1, wherein said plush tail is one of a monkey tail, a raccoon tail, a pig tail and a mouse tail.

3. The bookmark of claim 2, wherein said card member comprises a bi-fold member and said plush tail comprises an elongated strip having an end thereof attached to a proximal end of said plush tail, and wherein said elongated strip is disposed between opposing surfaces of said bi-fold member.

4. The bookmark of claim 3, wherein said opposing surfaces of said bi-fold member comprise an adhesive.

5. The bookmark of claim 1, wherein said card member comprises one of paper, card stock, plastic, and vinyl.

6. The bookmark of claim 5, wherein said card member comprises a bi-fold member and said plush tail comprises an elongated strip having an end thereof attached to a proximal end of said plush tail, and wherein said elongated strip is disposed between opposing surfaces of said bi-fold member.

7. The bookmark of claim 6, wherein said opposing surfaces of said bi-fold member comprise an adhesive.

8. The bookmark of claim 1, wherein said card member comprises a polymeric material.

9. The bookmark of claim 1, wherein said plush tail comprises a length of elongated bendable wire.
